(19) United States
(12) Patent Application Publication
(10) Pub. No.: US 2002/0191610 A1
(43) Pub. Date: Dec. 19, 2002

(54) Message transmission method and system capable of transmitting differential data

(76) Inventors: WonIn Baek, SeongNam-Si (KR); YunSik Jung, SeongNam-Si (KR); SangHyeok Nam, SeongNam-Si (KR)

Correspondence Address: PENNIE & EDMONDS LLP, 1667 K STREET NW, SUITE 1000, WASHINGTON, DC, 20006

(21) Appl. No.: 09/983,290

(22) Filed: Oct. 23, 2001

(30) Foreign Application Priority Data
Jun. 18, 2001 (KR) 2001-34452

(51) Int. Cl. H04L 12/28

(52) U.S. Cl. 370/390; 370/386

(57) ABSTRACT

The present invention relates to a message transmission method and system capable of transmitting differential data, which is implemented to improve data transmission rate by transmitting only differential data between the previously transmitted data and the current transmitting data when transmitting the data from a transmitting side to a receiving side.

According to the present invention, there is provided a method for transmitting differential data in a message transmission system including at least one stations for transmitting and receiving packet data to and from a transmission media by means of a media access control, and a plurality of transceivers coupled to the stations for communicating with the stations through the transmission media and performing a variety of applications by using the packet data received from the stations, wherein the differential data is data representing difference between a previously transmitted data and a current transmitted data, comprising the steps of: (a) receiving tuning channel request data including a channel ID from the plurality of transceivers; (b) generating a latest message buffer based on the channel ID received from the plurality of transceivers; (c) determining as to whether data representing a request for sending a latest message has been received from any one of the stations; (d) receiving data presenting differential data request signal from a corresponding transceiver connected to the station, in case it is determined that the data representing a request for sending a latest message has been received at step (c); (e) comparing the data received from the corresponding transceiver with message data stored in the latest message buffer; (f) generating the differential data by using different portions between each the compared data as a result of comparison at step (e); and (g) transmitting, in a multicast mode, the differential data generated at step (f) to the stations.

According to the present invention, it is possible to realize the message transmission method and system capable of transmitting the differential data, in which the data transmission rate can be improved by transmitting only differential data between the previously transmitted data and the current transmitting data so that the amount of data transmission can be reduced and the data transmission load can be relieved.

### FIELD OF THE INVENTION

The present invention relates to a message transmission method and system, and more particularly, to a message transmission method and system capable of transmitting differential data, which is implemented to improve data transmission rate by transmitting only differential data between previously transmitted data and current transmitting data when transmitting the data from a transmitting side to a receiving side.

### BACKGROUND OF THE INVENTION

Development of science and technology has provided a variety of convenience in our daily life. One of the typical examples of the development is the telecommunication technology. That is, since a person can transfer his/her messages through telecommunication media without coming to visit another person who is at a remote place, time required for coming to visit the other person can be utilized for other productive works.

In addition, even where the communication line is not connected through physical wire, it becomes possible to communicate with other persons at different remote places through wireless communication media while moving somewhere or doing something.

Furthermore, conventional communication technologies have provided communication users with only voice data by way of wire or wireless media. However, as the Internet appears, it allows a person to receive and transmit multimedia data including image data, picture data and motion picture data as well as the voice data, as long as he/she is only equipped with a communication device which accommodates the Internet communication.

That is, as the multimedia communication becomes widely available, information in connection with the business as well as the daily life including stock information, real estate information, real-time moving picture, music, on-line games, and the like has been facilitated.

Where a so-called intranet is constructed in a company or a building, a message transmission system, which has recently been spotlighted, is composed of a plurality of client systems that request necessary message data and a server system that provides the message data in response to the clients' request.

The server system is largely divided into two sections in view of its functionality: a station for performing data communication with other systems; and a transceiver running applications under the control of the station.

The station includes a count of the transceivers that are connected thereto, and also includes the IDs of other stations and also the counts of the transceivers that are connected thereto.

The station normally receives tuning signals from the transceivers connected thereto in relation to the channel establishment and processes the tuning signals so that it enters into a state where it can transmit the control signals to respective transceivers.

In such a state, if a request for data transmission is received from any transceivers, the station relays the request data to other stations. Thereafter, the station receives response data to the request data transmitted from the other stations and relays the response data to the requesting transceiver.

Meanwhile, as the volume of data transmitted through communication media grows, larger quantity of data comes and goes through the communication media. In line with this, the transmission rate becomes slowered since transmission load on the communication media is increased.

For example, where real-time stock quotations or prices are provided to customers on their displays by way of the Internet, the stock quotations and the prices ought to be updated and provided at each predetermined interval.

In general, the data concerning the stock quotations and the prices are characterized in that they are in large volumes, since the stock quotations and the prices of a lot of enlisted companies must be provided and the data thereof must be updated in every second.

Typically, the real-time stock-related information is transferred in such a manner that an arbitrary station receives the updated stock quotations from another station and then transmits them to the transceiver connected thereto.

By the way, even though only a small portion of the data on the stock quotations and prices are changed among the entire data while the remainings remain unchanged, the entire data, which are in large volumes, must be transmitted at every predetermined interval. This causes the transmission load for the data transmission to be unnecessarily heavy. As a result, the transmission rate becomes severely lowered.

### SUMMARY OF THE INVENTION

The present invention is contemplated to solve the above-described problems. An object of the present invention is to provide a message transmission method and system capable of transmitting differential data, which is implemented to improve data transmission rate by transmitting only differential data between the previously transmitted data and the current transmitting data when transmitting the data from a transmitting side to a receiving side in order to reduce the volume of data traffic.

According to an aspect of the present invention, there is provided a method for transmitting differential data in a message transmission system including at least one stations for transmitting and receiving packet data to and from a transmission media by means of a media access control, and a plurality of transceivers coupled to the stations for communicating with the stations through the transmission media and performing a variety of applications by using the packet data received from the stations, wherein the differential data is data representing difference between a previously transmitted data and a current transmitted data, comprising the steps of: (a) receiving tuning channel request data including a channel ID from the plurality of transceivers; (b) generating a latest message buffer based on the channel ID received from the plurality of transceivers; (c) determining as to whether data representing a request for sending a latest message has been received from any one of the stations; (d) receiving data presenting differential data request signal from a corresponding transceiver connected to the station, in case it is determined that the data representing a request for sending a latest message has been received at step (c); (e) comparing the data received from the corresponding transceiver with message data stored in the latest message buffer; (f) generating the differential data by using different portions between each the compared data as a result of comparison at step (e); and (g) transmitting, in a multicast mode, the differential data generated at step (f) to the stations.

According to another aspect of the present invention, there is provided a message transmission system capable of transmitting differential data, wherein the differential data is data representing difference between a previously transmitted data and a current transmitted data, comprising: a plurality of transceivers, each transceiver including a TCP (Transmission Control Protocol) connection unit for transmitting data based on a TCP, a HTTP (Hyper Text Transfer Protocol) control unit for controlling transmission of hypertext documents, a count storage unit for storing serial count numbers of transceivers, a memory for temporarily storing the data, and a transceiver control unit for controlling overall operations of the transceiver; and a plurality of stations, each station including a TCP connection unit for transmitting the data to the transceiver based on the TCP, a HTTP control unit for transmitting the hypertext documents, a UDP (User Datagram Protocol) connection unit for transmitting the data to the other stations based on a UDP, a latest message buffer for temporarily storing a current sequence number, a latest sequence number and received data, a station control unit for controlling overall operations of the station, and a channel ID storage unit for storing channel IDs of said other stations and counts of a plurality of transceivers which are connected to the stations, wherein, when request for transmission of a latest message is received from at least one of the stations, the stations receive the data relevant to differential data request signal from the transceivers connected thereto, compare the data received from the transceivers with message data generated in the latest message buffer, generate the differential data by extracting portions different from each other among the compared data, and transmit in a multicast mode the generated differential data to the stations.

### BRIEF DESCRIPTION OF THE DRAWINGS

The above and other objects and features of the present invention will become apparent from the following description of preferred embodiments given in conjunction with the accompanying drawings, in which:

FIG. 1 is a block diagram schematically showing the constitution of a message transmission system capable of transmitting differential data in accordance with the present invention;

FIG. 2 is a block diagram schematically describing an internal constitution of transceiver 10 shown in FIG. 1;

FIG. 3 is a block diagram schematically describing an internal constitution of station 20 shown in FIG. 1;

FIG. 4 is a flow diagram explaining the operations of a transmitting station in a method for transmitting the differential data, which is performed in the message transmission system; and

FIG. 5 is a flow diagram explaining the operations of a receiving station in the method for transmitting the differential data, which is performed in the message transmission system.

### DETAILED DESCRIPTION OF THE PREFERRED EMBODIMENTS

Hereinafter, a preferred embodiment of the present invention will be described in detail with reference to the accompanying drawings.

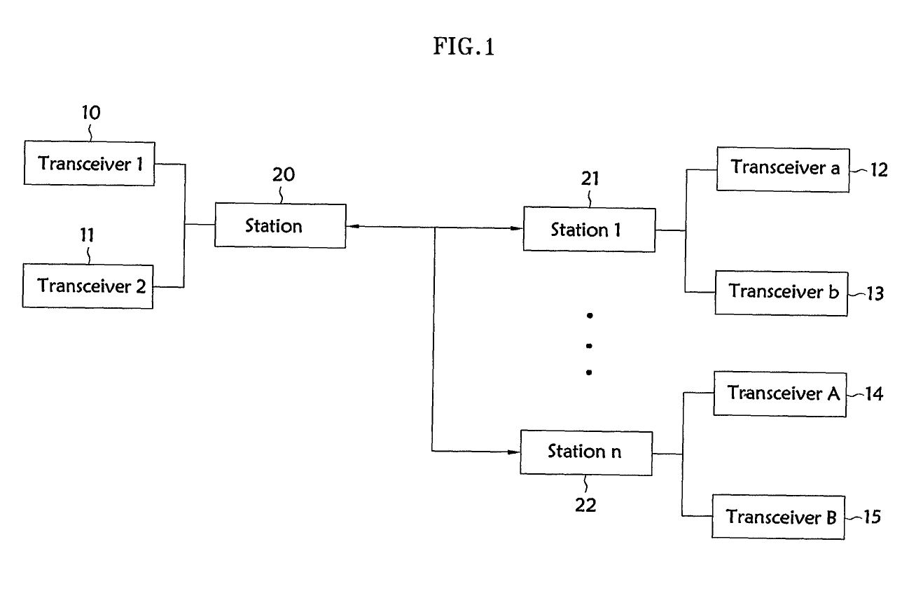

FIG. 1 is a block diagram schematically showing the constitution of a message transmission system capable of transmitting differential data in accordance with the present invention.

Referring to FIG. 1, the message transmission system includes transceivers 10, 11, 12, 13, 14, 15 serving as server applications in an intranet system, and stations 20, 21, 22 in charge of transmitting and receiving data in a packet format to and from the transmission media connected thereto.

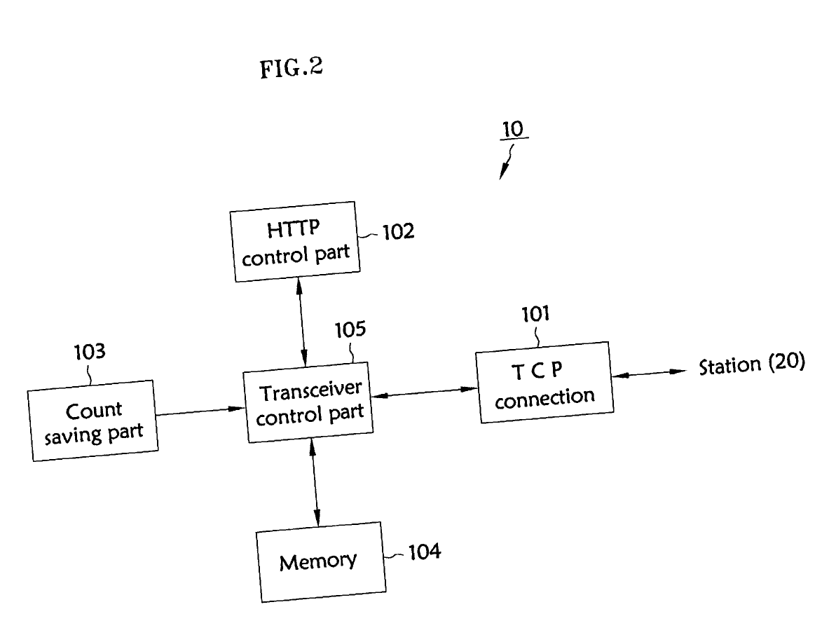

FIG. 2 is a block diagram describing the internal structure of the transceiver 1 10 shown in FIG. 1.

The transceiver1 10 is electrically connected to the station 20, and includes a TCP connection unit 101 for transmitting the data through a TCP (Transmission Control Protocol), a HTTP (Hyper Text Transfer Protocol) control unit 102 for controlling the transmission of hypertext documents, a count storage unit 103 for storing the serial count number of the transceiver 10, a memory 104 for temporarily storing the data, and a transceiver control unit 105 for controlling the overall operation of the transceiver 10.

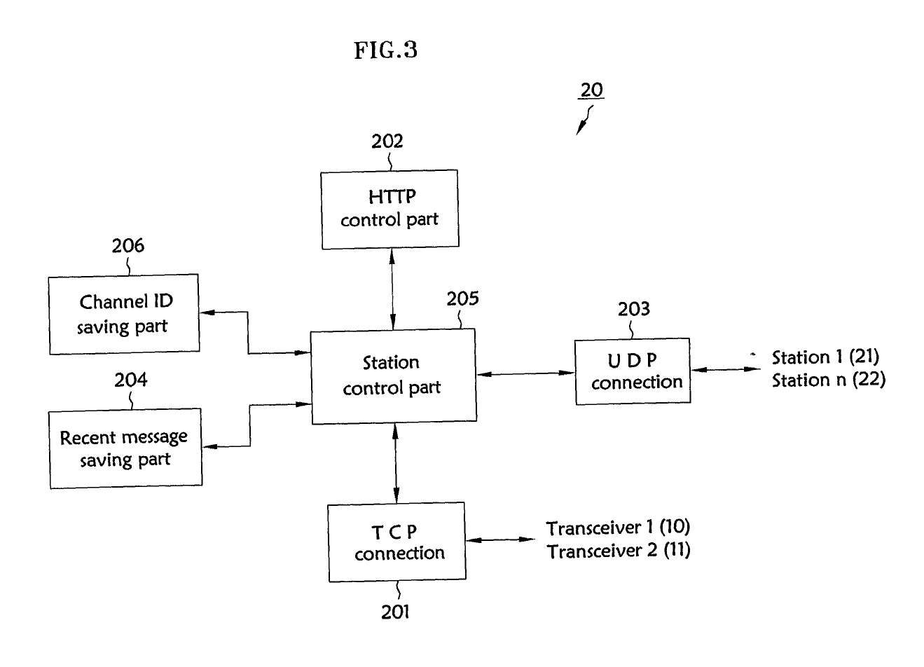

FIG. 3 is a block diagram describing a detailed internal structure of the station 20 shown in FIG. 1.

The station 20 includes a TCP connection unit 201 for transmitting the data based on the TCP, a HTTP control unit 202 for transmitting the hypertext documents, a UDP (User Datagram Protocol) connection unit 203 for transmitting the data based on a UDP, a latest message buffer 204 for temporarily storing a current sequence number, a latest sequence number, and the received data, a station control unit 205 for controlling the overall operation of the station 20, and a channel ID storage unit 206 for storing IDs of other stations and counts of a plurality of transceivers connected to the stations, sorted according to respective channels.

The station 20 as described above communicates with other stations through UDP connection unit 203 in a multicast mode, while communicates with transceivers connected thereto through TCP connection unit 201 in a unicast mode.

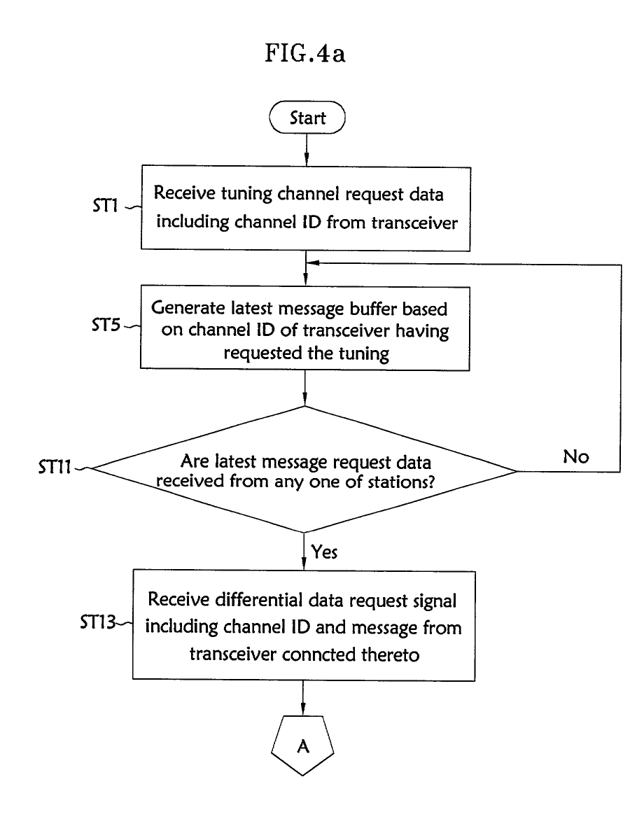

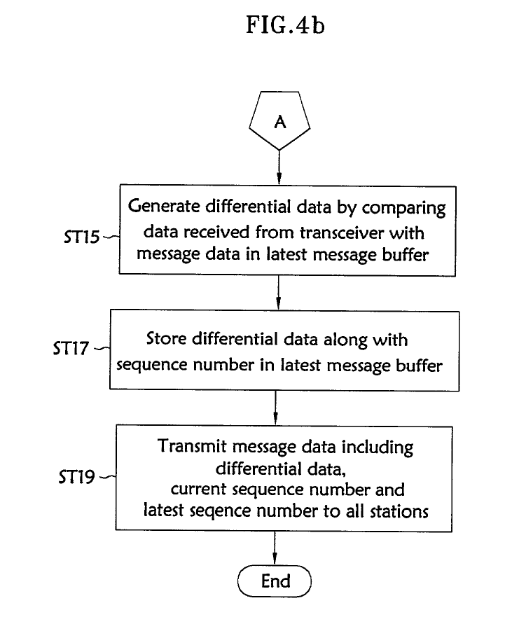

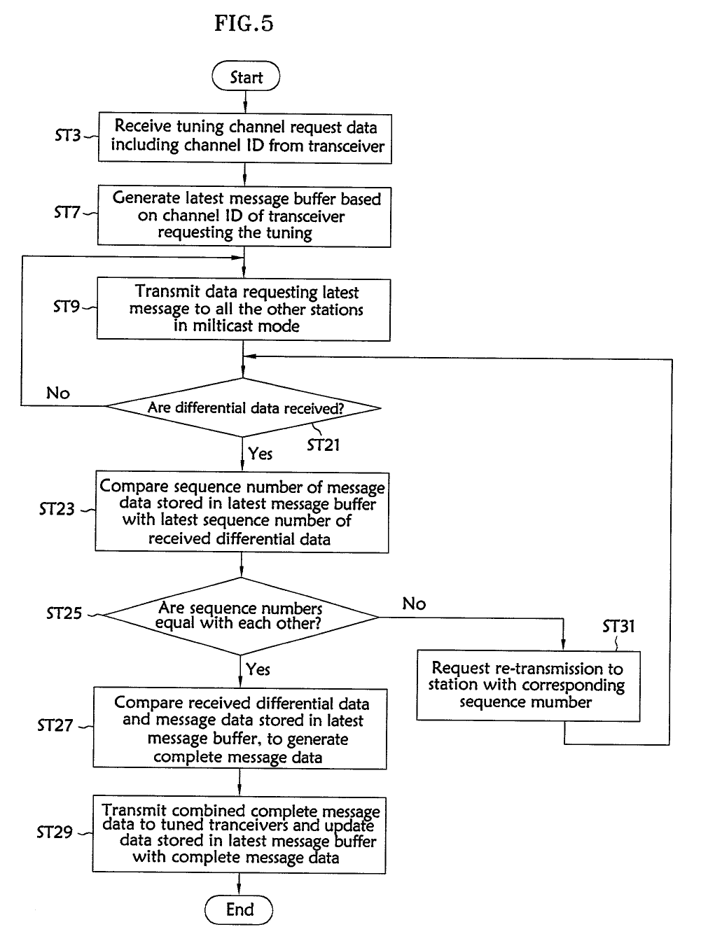

Next, the operation of the message transmission system as described above will be described with reference to flow diagrams of FIGS. 4 and 5.

For the purpose of illustration, it is assumed that the station 20 as shown in FIG. 1 is set as the transmitting station and the station1 21 is set as the receiving station.

FIG. 4 is the flow diagram for explaining the operations of the transmitting station 20 in the method for transmitting the differential data, which is performed in the message transmission system; while FIG. 5 is the flow diagram for explaining the operations of the receiving station1 21.

First of all, a plurality of the transceivers including transceivers1 and 2 10, 11 both of which are connected to the transmitting station 20 and transceivers a and b 12, 13 both of which are connected to the receiving station 21 transmit the data to the stations to which the transceivers are connected by using a URL-based channel ID.

To this end, each of the transceivers transmits the tuning channel request data to the station which is connected thereto for the purpose of tuning the URL-based channel i.e. TuneChannel_Request including the channel ID, wherein the tuning is performed in order to establish a channel for the data transmission to the station.

As for the transmitting system, the transmitting station 20 receives the tuning channel request data, i.e. TuneChannel_Request including the channel ID from the plurality of the transceivers including the transceiver1 10 which are connected thereto (step ST1).

As for the transmitting station 20, upon receiving the tuning channel request signal from at least one of the transceivers, the station control unit 205 generates an ID list which sorts IDs of the transceivers having requested the channel tuning by respective channels and then stores the ID list in the channel ID storage unit 206.

When all the other stations including the receiving station 21 as well as the transmitting station 20 also receive the tuning channel request signals from any one of the transceivers which are connected respectively thereto, they generate the ID list of the transceivers having requested the channel tuning and then stores them in the respective channel ID storage units thereof (step ST3).

For the purpose of illustration, the present invention will be described by way of example assuming that the transmitting station 20 and the receiving station 1 21 receive the tuning channel request data, respectively, from the transceiver 1 10 and the transceiver a 12 which are respectively connected to them.

In steps ST1 and ST3, the transceivers desirous of transmitting the differential data send the tuning channel request data, TuneChannel_Request, by using the request channel ID by way of setting a differential data transmission flag, i.e. DiffDataDelivery_Flag as True.

Subsequently, upon receiving the tuning channel request data from the transceiver1 10, the transmitting station 20 generates a latest message buffer based on the requested channel ID (step ST5).

The receiving station1 21 also generates a latest message buffer based on, for example, the channel ID of the transceiver a 12 requesting the tuning.

In the above state, the receiving station1 21 sends the data having the latest sequence number in the latest message buffer thereof, i.e., the data (Multicast Message for Differential Data Deliver) for requesting the latest message for a corresponding channel ID to all stations in the multicast mode (step ST9).

Meanwhile, the transmitting station 20, which has received the data for requesting the latest message from the receiving station1 21 (step ST11), receives data (DiffDataDelivery_Request) concerning a differential data request signal including the channel ID and the messages, through the TCP connection units 101, 201 from the transceiver1 10 (step ST13).

Then, the transmitting station 20 compares the data received from the transceiver1 10 with the message data stored in the latest message buffer 204, so that the differential data are generated based on the difference therebetween (step ST15).

The transmitting station 20 stores both the newly generated differential data and the sequence number in the latest message buffer 204 and add the newly generated differential data and the sequence number to the existing data in the latest message buffer 204 (step ST17)

Subsequently, the station control unit 205 of the transmitting station 20 transmits the message data including the newly generated differential data, the current sequence number, and the latest sequence number, in the multicast mode through the UDP connection unit 203 to all stations (step ST19).

Meanwhile, Referring to the receiving station1 20, when it receives the differential data from the transmitting station 20 after requesting the latest message (step ST21), it compares the sequence number of the message data, which have been stored in the latest message buffer thereof, with the latest sequence number of the received differential data (step ST23).

If it is determined from the compared result that the sequence numbers are equal to each other (step ST25), the receiving station1 21 combines the received differential data and the message data, which have been stored in the latest message buffer thereof, to generate complete message data (step ST27).

Subsequently, the receiving station1 21 transmits the combined complete message data to the tuned transceivers which are connected thereto, and updates the data, which have been stored in the latest message buffer thereof, with the complete message data (step ST29).

At step ST25, if the compared sequence numbers are equal to each other, this indicates that the previously received data and the current received data are the same type of data. On the other hand, if they are not equal to each other, the receiving station1 21 requests the station with the corresponding sequence number having transmitted the data, i.e. the transmitting station 20, to re-transmit the data (step ST31).

Then, the procedure returns to the step ST21, and processes the data, which are received by means of the request of the re-transmission, through the above steps.

As described above, according to the preferred embodiment of the present invention, it is possible to reduce a traffic load while transferring the message data between the stations by transmitting only the differential data after firstly transmitting full message data in the message transmission system, and consequently, to achieve the fast data transmission.

In other words, according to the present invention as described above, it is possible to realize the message transmission method and system capable of transmitting only differential data between the previously transmitted data and the current transmitting data, whereby the volume of transferred data can be drastically reduced and, thus, lighter data transmission load can be achieved.

While the invention has been shown and described with respect to the preferred embodiments, it will be understood by those skilled in the art that various changes and modifications may be made without departing from the spirit and scope of the invention as defined in the following claims.

What is claimed is:

1. A method for transmitting differential data in a message transmission system, the message transmission system including at least one stations for transmitting and receiving packet data to and from a transmission media by means of a media access control, and a plurality of transceivers coupled to the stations for communicating with the stations through the transmission media and performing a variety of applications by using the packet data received from the stations, wherein the differential data is data representing difference between a previously transmitted data and a current transmitted data, comprising the steps of:
(a) receiving tuning channel request data including a channel ID from the plurality of transceivers;
(b) generating a latest message buffer based on the channel ID received from the plurality of transceivers;
(c) determining as to whether data representing a request for sending a latest message has been received from any one of the stations;
(d) receiving data presenting differential data request signal from a corresponding transceiver connected to the station, in case it is determined that the data representing a request for sending a latest message has been received at step (c);
(e) comparing the data received from the corresponding transceiver with message data stored in the latest message buffer;
(f) generating the differential data by using different portions between each the compared data as a result of comparison at step (e); and
(g) transmitting, in a multicast mode, the differential data generated at step (f) to the stations.

2. The method as claimed in claim 1, further comprising the step of (f1) storing the differential data generated at step (f) and a sequence number in the latest message buffer between steps (f) and (g).

3. The method as claimed in claim 2, wherein the differential data transmitted at step (g) is message data including a current sequence number and a latest sequence number.

4. The method as claimed in claim 3, wherein if it is determined that a latest sequence number of the differential data received at step (g) is equal to a latest sequence number stored in the stations which received the differential data at step (g) as a result of a comparison by the stations, the stations which generate complete message data by combining the differential data received at step (g) with the differential data stored in the latest message buffer, and transmits the complete message data to the plurality of transceivers connected thereto.

5. The method as claimed in claim 4, wherein the stations which received the differential data at step (g) replaces the data stored in the latest message buffer thereof with the complete message data.

6. The method as claimed in claim 4, wherein if a latest sequence number of the differential data received at step (g) is not equal to a latest sequence number stored therein, the stations which received the differential data at step (g) request a station corresponding to each sequence number to re-transmit the differential data.

7. A message transmission system capable of transmitting differential data, wherein the differential data is data representing difference between a previously transmitted data and a current transmitted data, comprising:
a plurality of transceivers, each transceiver including a TCP (Transmission Control Protocol) connection unit for transmitting data based on a TCP, a HTTP (Hyper Text Transfer Protocol) control unit for controlling transmission of hypertext documents, a count storage unit for storing serial count numbers of transceivers, a memory for temporarily storing the data, and a transceiver control unit for controlling overall operations of the transceiver; and
a plurality of stations, each station including a TCP connection unit for transmitting the data to the transceiver based on the TCP, a HTTP control unit for transmitting the hypertext documents, a UDP (User Datagram Protocol) connection unit for transmitting the data to the other stations based on a UDP, a latest message buffer for temporarily storing a current sequence number, a latest sequence number and received data, a station control unit for controlling overall operations of the station, and a channel ID storage unit for storing channel IDs of said other stations and counts of a plurality of transceivers which are connected to the stations,
wherein, when request for transmission of a latest message is received from at least one of the stations, the stations receive the data relevant to differential data request signal from the transceivers connected thereto, compare the data received from the transceivers with message data generated in the latest message buffer, generate the differential data by extracting portions different from each other among the compared data, and transmit in a multicast mode the generated differential data to the stations.

8. The message transmission system of claim 7, wherein the stations store both the generated differential data and the sequence number stored in the latest message buffer thereof.

9. The message transmission system of claim 8, wherein the differential data transmitted to the stations are message data including a current sequence number and a latest sequence number.

10. The message transmission system of claim 9, wherein when it is determined that a latest sequence number of the received differential data is equal to a latest sequence number of the receiving station upon comparison therewith, a receiving station which receives the differential data generates complete message data by combining the received differential data with said data stored in the latest message buffer, and transmits the complete message data to said transceiver connected thereto.

11. The message transmission system of claim 10, wherein the receiving station replaces the data stored in the latest message buffer thereof with the complete message data newly generated.

12. The message transmission system of claim 10, wherein the receiving station requests a station corresponding to a pertinent sequence number to re-transmit the differential data thereto, when the latest sequence number of the received differential data is not equal to the latest sequence number thereof.
